(19) United States
(12) Patent Application Publication
(10) Pub. No.: US 2006/0122899 A1
(43) Pub. Date: Jun. 8, 2006

(54) Comprehensive online shopping management system

(75) Inventors: Antony H. Lee, Greenwich, CT (US); Camilo E. Cucalon, Somers, NY (US)

Correspondence Address: COLEMAN SUDOL SAPONE, P.C., 714 COLORADO AVENUE, BRIDGE PORT, CT, 06605-1601, US

(73) Assignee: ADVANCED COMMERCE STRATEGIES, INC., Greenwich, CT (US)

(21) Appl. No.: 11/245,567

(22) Filed: Oct. 7, 2005

Related U.S. Application Data
(60) Provisional application No. 60/617,335, filed on Oct. 8, 2004.

(51) Int. Cl. G06Q 30/00

(52) U.S. Cl. 705/26

(57) ABSTRACT

An online shopping management system is a computer system including at least one server computer. The computer system is provided with software for assisting customers in recording and organizing information pertaining to purchases made by the customers over a global computer network from a plurality of different merchants via a plurality of different websites. An electronic shopping method includes automatically monitoring each screen displayed on a user's computer monitor while the user navigates the World Wide Web, automatically collecting particulars of purchase transactions engaged in by the user, storing in a memory the particulars of the transactions and of multiple-online purchases made by the user, and providing to the user a summary display of collected and stored information pertaining to the online purchases made by the user.

### BACKGROUND OF THE INVENTION

The invention relates to shopping done over the global computer network known as the Internet. More particularly, this invention relates to a method and an associated system for assisting users in managing every aspect of their online purchases.

The selling of goods and services via the Internet and more particularly via the World Wide Web is increasing each year and continues to increase. Consumers find convenience in shopping at their computers and having goods delivered to them at their homes or places of business. As this electronic commerce increases, consumers will find that tracking and managing their shopping activity is becoming more difficult.

Thus, there is a need for a system that provides Internet users with assistance in monitoring and managing their online purchasing activity. Moreover, as consumers make increasing numbers of purchases via the Internet, certain aspects of their activity becomes increasingly inefficient due to the number of merchant sellers they deal with, the number of packages they need to receive, and the amount they pay for shipping and handling charges.

### OBJECTS OF THE INVENTION

An object of the present invention is to provide a method and/or an associated system for assisting consumers in managing their purchase transactions carried out over the Internet.

A further object of the present invention is to provide a method and/or an associated system for enabling consumers fundamentally to change the way they shop on the Internet by shifting responsibility for the flow of information and the shipping of products from the merchant to the consumer herself.

A more particular object of the present invention is to provide such a method and/or an associated system that automatically tracks or monitors consumer purchases.

Another object of the present invention is to provide such a method and/or system that facilitates the completion of consumer transactions.

A further object of the present invention is to provide such a method and/or system that provides information to the consumer as to shipping status.

Yet another object of the present invention is to provide such a method and/or system that facilitates the return of purchased goods.

These and other objects of the invention will be apparent from the descriptions and drawings herein. Although every object of the invention is believed to be attained in at least one embodiment of the invention, there is not necessarily any single embodiment that achieves all of the objects of the invention.

### SUMMARY OF THE INVENTION

The present invention is directed to a business system that provides a single point of entry for users to order and manage all aspects of their Internet e-commerce activities. This system provides a way for users to order from multiple online retailers and service providers though a single point of entry. Utilizing a single consolidated view (i.e. a control panel), users are able to monitor and track the status and progress of their orders and returns. This business system may be called a “Comprehensive Online Shopping Management System” (COSMOS).

An online shopping management method comprises, in accordance with the present invention, automatically monitoring each screen displayed on a user's computer monitor while the user navigates the World Wide Web, automatically determining whether the user is engaged in a transaction during the monitoring of each screen, automatically collecting particulars of a transaction upon detecting that the user is engaged in a transaction, storing in a memory the particulars of the transaction and the particulars of multiple online transactions made by the user, and providing to the user a summary display of collected and stored information pertaining to the online transactions made by the user.

The present invention is directed in general to a comprehensive online shopping management system (COSMOS) that provides consumers with a methodology for creating efficiencies and cost reductions in the online shopping process. More specifically, the COSMOS system enables consumers fundamentally to change the way they shop on the Internet by shifting responsibility for the flow of information and the shipping of products from the merchant to the consumer herself. The COSMOS system changes and alters the way consumers complete, manage and control the entire end to end process of shopping on the web.

The present invention contemplates that the software to enable consumers to use COSMOS as a shopping management tool exists either on the consumers' computers (which the consumer computers receive via a download from a COSMOS system computer or from an authorized COSMOS distributor), and/or on COSMOS' own servers which overlay COSMOS' functionalities to the consumers' shopping experience because they are directed by their ISP, COSMOS itself or other intermediary to shop through COSMOS' servers each time they shop on the Internet. Some functions or operations of the electronic shopping management system may be performed on the consumers' computers while other functions or operations are performed on the COSMOS servers. Functions or operations performed on users' computers may be executed via a browser plug-in or via separate software that may communicate with and interact with browser applications. In one alternative load-sharing paradigm, any given function or operation may be performed partially on the consumers' computers and partially on the COSMOS servers. Also, the functions and operations performed by the COSMOS servers may be distributed among different computers. Generally, it is contemplated that the transactions which are managed by the system include multiple online purchases, for instance, of consumer goods and services, and business goods and services. The monitored transactions may also include requests for “free” items such as catalogs and information. The online shopping summary may be provided to the user in the form of a dashboard, control panel, or other format that facilitates user inspection and use of the shopping management method or system.

The word “screen” or “display” is used here to refer to all or a portion (a window) of a computer monitor display screen. A screen presenting purchase transaction information in summary format may include graphics but preferably includes screen areas with lists or tables of alphanumeric text material identifying purchases by at least some of the following purchase particulars: the item purchased, the type of item, the merchant or seller, the mode of shipment including the carrier, total costs, tax paid, shipping cost, and/or estimated delivery date.

The adverb “automatically” or adjective “automatic” as used here designates activities performed by computer, generally without human intervention, except for usual monitoring, supervision, maintenance, and updating or improvement operations.

Pursuant to another feature of the present invention, the providing of the summary display includes organizing the displayed information according to any one of a plurality of different sorting schemes. Where the collected and stored particulars for each online purchase made by the user include an identification of a type of consumer item purchased, an identification of a seller of the consumer item purchased, and a purchase price, the different sorting schemes include listing displayed information by type of item purchased, by seller, and by price. Where the collected and stored particulars for each online purchase made by the user include shipping fees and taxes paid, the different sorting schemes include listing displayed information by shipping fees and taxes paid.

The providing of the summary display may include displaying information pertaining to shipping status of purchased items. The displayed shipping status may include shipment method and expected delivery date. The displayed status may further include information about delays and shipping problems. The shipping status information is typically obtained from the shippers via the Internet and is sorted and organized for presentation to the respective users.

In accordance with a further feature of the present invention, the providing of the summary display includes interactive options for the user. The interactive options may particularly include shipping and return options selectable by the user to return purchased items. In that case the method further comprises displaying to the user information tracking the status of the shipments.

The present invention may thus involve an aggregation of online buyers into a singular unit or “client” group for shipping and logistics purposes. Pursuant to this agenda, the “shipper” is not the merchant but is instead the customer. The customer essentially sends his or her shipper to pick the merchandise up and deliver it. So, for example, a user of the shipping management system may utilize it to electronically signal a designated shipping company to pick up a purchased item at the user's home address or at the address of the merchant, and deliver it to the user's address or the merchant's address, and the system will electronically submit to the shipping company a unique billing number assigned to the user so that the user becomes responsible for managing the shipment and return of his purchase and is responsible for paying the cost of such shipment which will be automatically billed by the system to his credit card.

Pursuant to an additional feature of the present invention, the online shopping management method further comprises monitoring email of the user to and from different merchants. In that case, the providing of the summary display includes displaying information pertaining to email to and from the different merchants. The email to and from the different merchants may be automatically sorted, with the email particulars being displayed in sorted groups. The sorted groups may include by product type and by merchant, alternatively. In addition, the online shopping management method may comprise automatically reading the content of incoming email to determine whether the email contains confirmation numbers, shipping updates, or cancellation messages, i.e. information pertinent to transation or purchase order status. Such information is extracted out of the email and used to populate a relevant area of the control panel or display. Subsequently, a message is automatically sent to the user alerting him or her to the new order status.

Pursuant to further features of the present invention, the collected and stored particulars for each online purchase made by the user include an identification of a type of consumer item purchased, an identification of a seller of the consumer item purchased, and a purchase price. The collected and stored particulars for each online purchase made by the user may also include shipping fees and taxes paid.)

In accordance with another aspect of the present invention, the providing of the summary display includes automatically calculating sums of amounts spent on types of purchases in different categories. These subtotals are then provided in the summary display. The different categories may include a food category, a transportation category, a clothing category, and an entertainment category.

The present invention contemplates that the online shopping management method is performed while the user surfs the Web, making purchases at the Web sites of different merchants. Typically, at least some of the online purchases are made by the user after conducting a Web search using a search engine.

The collecting of particulars as to a purchase transaction may be implemented by screen scraper software.

The online shopping management method may further comprise storing consumer identification information pertaining to the user and automatically inserting individual pieces of the stored consumer identification information in respective data entry fields of a purchase screen on the user display. The automatically inserted identification information may include the user's name and shipping address, as well as a credit card number and expiration date. Where this consumer identification information is stored on a server computer, the individual may be required to use a personal identification number and a password in order to access his or her (or its) information, including purchase summary information, if that information is stored on a server computer,

The online shopping management method may additionally comprise displaying inbound shipping tracking information to the user. Thus, the user is made aware of the shipping status of various orders, on a continually or periodically updatable basis.

The online shopping management method may optionally comprise displaying credit card alerts to the user. Thus, a user may return a purchased item to a merchant. The system will track the return of such item and alert the user's credit card provider that a credit is due from the merchant. The system will then inform the user when such credit is received.

An online shopping management system in accordance with the present invention comprises a computer system including at least one server computer, the computer system being provided with software for assisting customers in recording and organizing information pertaining to purchases made by the customers over a global computer network from a plurality of different merchants via a plurality of different websites. Alternatively, the system might become activated when the user is directed to “shop” through the system's computers, so that whenever the user goes on the World Wide Web he invisibly takes along with him the system's tracking and recording devices.

Pursuant to a further feature of the present invention, the software includes software for automatically monitoring each screen displayed on a customer's computer monitor while the customer navigates the World Wide Web, automatically determining whether the customer is engaged in a purchase transaction, automatically collecting particulars of the transaction upon detecting that the customer is engaged in a purchase transaction, storing in a memory the particulars of the transaction and the particulars of multiple-online purchases made by the customer, and providing to the customer a summary display of collected and stored information pertaining to the online purchases made by the customer.

Pursuant to another feature of the present invention, the computer system is further provided with additional software taken from the group consisting of software for tracking status of merchandise shipping from the different merchants, software for tracking status of return merchandise shipments to the different merchants and by individual purchases, and software for tracking email to and email from any given customer pertaining to purchases made by the given customer.

The additional software may include (a) programming for displaying information pertaining to shipping status of purchased items, (b) programming for displaying and acting on options selectable by the customer to return purchased items, and/or (c) programming for displaying information pertaining to email to and from the different merchants. The programming for displaying email information pertaining to transactions or purchase orders may include programming for automatically identifying and extracting, from incoming email, confirmation numbers, shipping updates, or cancellation messages, i.e. information pertinent to transation or purchase order status. Such information is used to update the information displayed for the user. A message may be automatically sent to the user alerting him or her to updates in order status.

Pursuant to yet another feature of the present invention, the computer of the shopping management system may be programmed with additional software for calculating sums of amounts spent by individual customers on types of purchases in different categories.

A business method in accordance with the present invention comprises (a) communicating with customers via a global computer network, (b) assisting the customers via the global computer network in recording and organizing information pertaining to purchases made by the customers over the global computer network from a plurality of different merchants via a plurality of different websites, (c) extending to the customers at least three services taken from the group consisting of (i) providing credit card alerts to the customers via the computer network, (ii) tracking merchandise shipments, (iii) providing insurance against incomplete merchandise receipt, (iv) providing an extended return period, providing a guaranteed return period, (v) providing an extended warranty period, (vi) providing a guaranteed warranty period, (vii) providing insurance on returned merchandise, (viii) providing frequent buyer points, (ix) providing gift cards, and (x) providing an alternative dispute resolution procedure, and (d) aggregating users into a single cohesive “client” or “group” so that the users become an entity whereby each user can organize, control, manage, and pay for, his own individual shipping and return functions as they relate to items purchased and recorded on the system.

Additional services extended to customers in an on-line shopping management system pursuant to the present invention may include shipment holding features, for example, holding users' purchases while the users are on vacation. Another service is to provide, to selected merchants, additional shipping methods such as local store pick-ups.

The business method may further comprising providing additional software taken from the group consisting of software for tracking status of merchandise shipping from the different merchants, software for tracking status of return merchandise shipments to the different merchants and by individual purchases, and software for tracking email to and email from any given customer pertaining to purchases made by the given customer.

### BRIEF DESCRIPTION OF THE DRAWINGS

FIG. 1 is a block diagram of an Internet-based shopping management system in accordance with the present invention, showing a comprehensive online shopping management system (COSMOS) server computer.

FIG. 2 is a block diagram of the server computer of FIG. 1, showing a shopping management unit, a pair of shipping tracking units, and an email tracking unit.

FIG. 3 is a block diagram of the shopping management unit of FIG. 2.

FIG. 4 is a block diagram of an incoming shipping tracking unit shown in FIG. 3.

FIG. 5 is a block diagram of a returns shipping tracking unit shown in FIG. 3.

FIG. 6 is a block diagram of the email tracking unit shown in FIG. 3.

### DEFINITIONS

The term “transaction” as used herein denotes an event involving a transfer of goods or services and/or monetary funds. Where goods or services are exchanged for a monetary amount, the transaction may be characterized as a commercial transaction. However, some transactions may not involve the transfer of monetary amounts. For example, a transaction could be a barter activity or a consignment. A transaction may involve the transfer of funds in one direction without an accompanying transfer in the opposite direction, as in the case of a charitable contribution. A transaction may involve the transfer of funds in one direction with a transfer of one or more financial instruments (stocks, bonds, futures, options, warrants, calls, puts, etc) or other monetary amount (as in a currency transfer) in the opposite direction.

The word “automatically” or “automatic” is used herein to denote an activity, operation, function, or process that is executed by a computer or computer system without human intervention. For instance, a computer or computers performing a transaction management process as disclosed herein are programmed to carry out operations of monitoring screens displayed on a user's computer monitor while the user navigates the World Wide Web, determining whether the user is engaged in a transaction during the monitoring of each screen, collecting particulars of a transaction upon detecting that the user is engaged in a transaction, etc. Further automatic processes may include storing in a memory the particulars of the transaction and the particulars of multiple online transactions made by the user, and providing to the user a summary display of collected and stored information pertaining to the online transactions made by the user.

The term “automatically monitoring” is used herein to denote a software-mediated reading, scanning or examining of information on a computer screen to detect, for instance, whether a screen is one in which a user may be executing an on-line transaction. Thus, automatic monitoring pursuant to the instant disclosure does not contemplate the exercise of visual perception.

The term “automatically collecting” as in the phrase “automatically collecting particulars of a transaction” is used to denote a software-implemented extraction of data or information. This may involve accessing a computer RAM to transfer (and duplicate) information from one part of the RAM to another part of the RAM and optionally to permanent storage location in a nonvolatile computer memory.

The word “screen” is used herein to denote the collective textual and graphic information displayed on a computer monitor at any particular instance during computer usage. The term “screen” may also denote a changing pattern of information displayed on a computer monitor.

The term “provider” is used herein to designate a party with whom a computer interacts on-line via the World Wide Web and the underlying global computer network known as the Internet in order to carry out a transaction. A provider may be a merchant of goods and/or services. A provider may be a financial service provider such as a stock broker, a bank, a mutual fund, a commodities dealer, etc. or a provider may be a charitable institution

### DETAILED DESCRIPTION

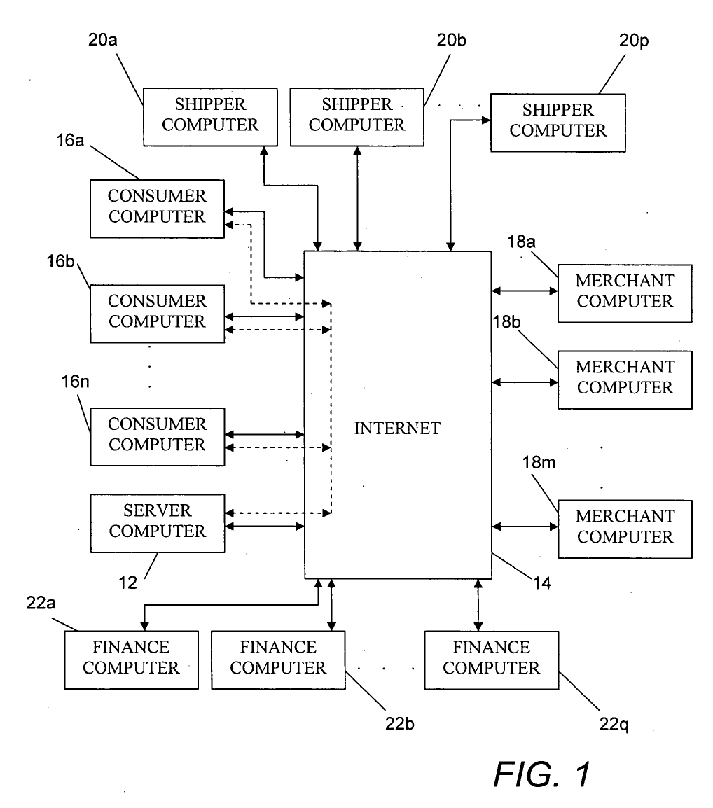

An online shopping management system illustrated in FIG. 1 is a computer system including at least one server computer 12 connected to the global computer network known as the Internet 14 for cooperating with consumer computers 16a, 16b, . . . 16n to monitor, track, manage, organize, and facilitate purchase transactions made by individual and/or corporate (business) consumers over the Internet. The purchase transactions involve communication between the consumer computers 16a, 16b . . . . . . . 16n, on the one hand, and multifarious merchant computers 18a, 18b, . . . 18m, on the other hand. Merchant computers 18a, 18b, . . . 18m include all computers that cooperate with one another on the merchant side to implement sales transactions.

The online shopping management system of FIG. 1 further includes shipper computers 20a, 20b, . . . 20p and credit card/banking computers 22a, 22b, . . . 22q. Shipper computers 20a, 20b, . . . 20p provide information as to the status of shipments and may be used to enable merchandise returns. Financing or credit card/banking computers 22a, 22b, . . . 22q include computers owned by credit card companies, as well as bank computers that permit online purchases using debit card accounts and electronic funds transfer.

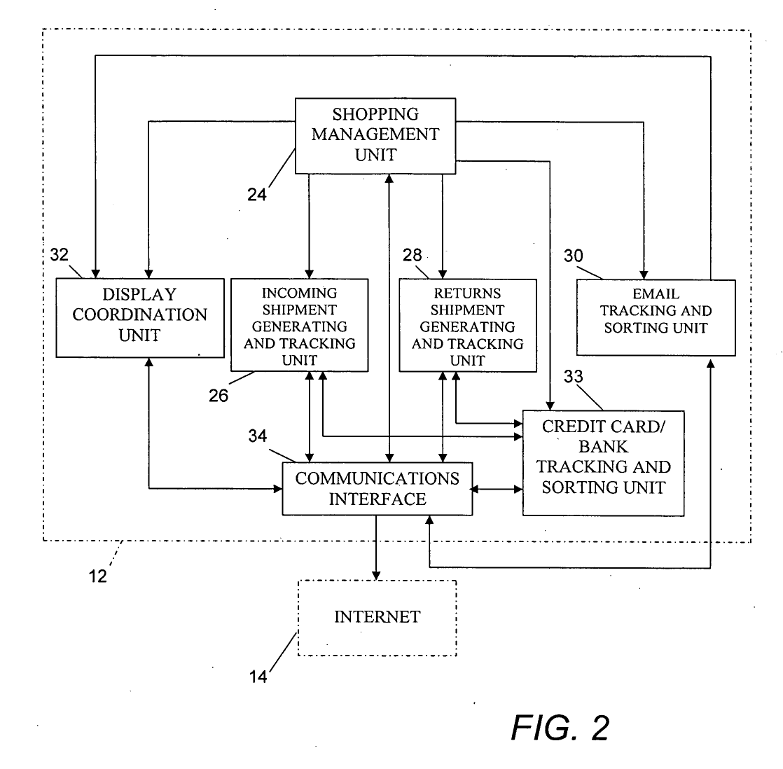

As discussed in detail hereinafter, the online shopping management system of FIG. 1, particularly server computer 12, is provided with software for assisting customers in recording and organizing information pertaining to purchases made by via consumer computers 16a, 16b, . . . 16n over the Internet 14 from a plurality of different merchants via a plurality of different websites maintained by respective merchant computers 18a, 18b, . . . 18m. This assistance is provided in the form of a personalized and customizable dashboard or control panel that is produced or reproduced in visually cognizable form on the monitors of consumer computers 16a, 16b, . . . 16n. As depicted in FIG. 2, the software on server 12 modifies generic digital circuitry of the server computer to define or create a shopping management unit 24, incoming shipment generation and tracking unit 26, a returns shipment generation and tracking unit 28, an email tracking and sorting unit 30, and a software-implemented display coordination unit 32. These units 24, 26, 28, 30, and 32 cooperate under the control and coordination of shopping management unit 24 to generate and provide the dashboard or control panel on the consumer computers 16a, 16b, . . . 16n. Server computer 12 also includes a software-implemented credit card/bank tracking and sorting unit 33 that holds user shopping information and simulates interfaces with shipping and payment tracking systems. Tracking and sorting unit 33 is connected to units 26 and 28, on the one hand, and to the Internet 14, on the other hand, for coordinating payments and refunds with credit card/banking computers 22a, 22b, . . . 22q.

As discussed in greater detail below, software-implemented shopping management unit 24 monitors consumer computers 16a, 16b, . . . 16n to detect shopping transactions as they are occurring. As discussed below, unit 24 may memorize or store shipping and payment particulars of the different customers for insertion into appropriate fields in an HTML or XML display screen. Shopping management unit 24 may carry out ancillary functions such as facilitating product marketing by utilizing user order data to provide targeted ads to the consumer computers 16a, 16b, . . . 16n via shopping management control panel or “dashboards” (see below).

Consumer computers 16a, 16b, . . . 16n are provided with web browser plug-ins, which are applications that run within the customer's web browser to assist in the capture of shopping related transactions and to assist in the process of filling shopping web forms. The plug-ins also communicate with the COSMOS server computer 12 to transmit thereto the customer's order data and save the order data state. The browser plug-ins may also store various user credit and debit card numbers and other payment account information, as well as passwords associated with such accounts. User IDs and passwords for various Web sites may also be stored and automatically entered in appropriate user fields of shopping sites on the World Wide Web.

Consumer computers 16a, 16b, . . . 16n are further provided with email client plug-ins, namely, applications that run within the customer's email clients to assist in the capture of emails sent from merchants with whom the customer has engaged in one or more purchase transactions. The email client plug-ins provide order status updates to the COSMOS server 12 based on the information captured in the email. The COSMOS server 12 also provides email management capabilities, allowing the user to have COSMOS automatically filter emails from selected vendors from their primary email systems and send those emails into COSMOS. This will help the users reduce email clutter in their primary email systems and allow them to manage emails from vendors within the COSMOS system. Email plug-ins may use user feedback in the classification and extraction algorithms to enhance accuracy. In addition, the email plug-ins may enable the user to monitor whether the collected data is accurate and fix errors as warranted (this information may then used to enhance the accuracy of the algorithm).

Consumer computers 16a, 16b, . . . 16n are additionally provided with shopping management or desktop user interface software that cooperates with server 12 to enable the users to view their orders, order history, drill-down order information and other views summarizing their shopping activity. The shopping management or desktop user interface software also provides users with the ability to control COSMOS plug-ins settings and interact directly with COSMOS partner merchants.

Shopping management unit 24 of server computer 12 interacts with consumer computers 16a, 16b, . . . 16n and more particularly with the plug-ins and shopping management or desktop user interface software on those computers to implement the shopping management functions detailed herein. Those functions include the collection of order, merchant, pricing, payment, shipping, and order status information. Those functions may additionally include order cancellation, returns, and merchant email information; rewards points information; warranty information; and targeted marketing information. Software-implemented incoming shipment generation and tracking unit 26 issues commands to a shipping company to collect from any merchant specific items purchased online by the consumer, and to have such items delivered to the consumer's address. Unit 26 systemically sends the consumer's or COSMOS' unique charging number to the shipping company thereby charging COSMOS or the consumer for the requested shipping. In addition, unit 26 tracks the status of merchandise shipping from different merchants. Shipment generation and tracking unit 26 may periodically consult shipper computers 20a, 20b, . . . 20p via the Internet 14 to obtain updated information as to the status of customers' online purchases.

Software-implemented returns generation and tracking unit 28 issues commands to a shipping company to pick-up a return from the customer's house address or other address; alternatively, the system automatically generates a pre-paid return label that the consumer attaches to the return shipment and then she drops-off the return at an authorized drop-off point, such as a Post Office. To that end, unit 28 is connected via the shopping management or desktop user interface software on a user computers 16a, 16b, . . . or 16n to a user printer (not shown) for printing out shipping labels including, for instance, bar-type identification codes. In response to a request from a user computer 16a, 16b, . . . 16n, server 12 may submit and channel a pick-up request to a shipping provider. With respect to payment of the shipping costs, unit 28 may be connected to the Internet 14 via a communications interface 34 for purposes of contacting shipper computers 20a, 20b, . . . 20p to make automated payment or prepayment of the shipping charges.

In addition, returns shipment generation and tracking unit 28 tracks shipments to the different merchants of merchandise being returned by individual purchasers. Unit 28 may keep track of the locations of individual purchased items. As indicated, unit 28 may implement merchandise returns by contacting shipper computers 20a, 20b, . . . 20p via the Internet 14 to arrange for pickup and delivery of returns goods. Returns shipment generation and tracking unit 28 may communicate with shopping management unit 24 to update purchase information and to arrange for credits with the appropriate financial institutions via the respective computers 22a, 22b, . . . 22q. Returns shipment generation and tracking unit 28 may additionally check for and update payment statuses of orders. To that end, returns shipment generation and tracking unit 28 may interact with external banking and financial systems computers 22a, 22b, . . . 22q to update the status of credit card authorizations and charges. Returns shipment generation and tracking unit 28 may further monitor that returns are received back by the respective merchants and that the merchants have posted credits to the user's payment account. Fraud protection features may be incorporated into the COSMOS system by giving the user access to generated credit card numbers to use in his/her shopping experience. The amount can then be billed to the customer through his/her profile in COSMOS (i.e. through one of the following channels: membership an Internet Service Provider program, supplied credit card number, supplied bank routing information, etc.).

Software-implemented email tracking and sorting unit 30 monitors email to and email from any given consumer computer 16a, 16b, . . . 16n pertaining to purchases made by the respective customer. The monitoring of email by email tracking and sorting unit 30 may include automatically reading the content of incoming email to determine whether the email contains confirmation numbers, shipping updates, or cancellation messages, i.e. information pertinent to transation or purchase order status. Such information may be extracted out of the email and used to update a display of order status information. Email tracking and sorting unit 30 may also provide a message automatically to the user alerting him or her to the new order status.

As depicted in FIG. 2, software-implement display coordination unit 32 is connected to shopping management unit 24, incoming shipment generation and tracking unit 26, returns shipment generation and tracking unit 28, and email tracking and sorting unit 30 for generating on consumer computers 16a, 16b, . . . 16n display screens (e.g., a Web page) that list purchase transaction information, shipping status information, and email communications pertaining to online purchases. Display coordination unit 32 preferably organizes shopping summary information for presentation to the user in the form of a dashboard, control panel, or other format that facilitates use of the shopping management method or system to assist individual or business (corporate) consumers during and after purchases have been made. Display coordination unit 32 may communicate with consumer computers 16a, 16b, . . . 16n for purposes of customizing the dashboard or control panel to the particular users' preferences and inclinations.

Communications interface 34 distributes incoming information to shopping management unit 24, incoming shipment generation and tracking unit 26, returns shipment generation and tracking unit 28, and email tracking and sorting unit 30 and collects messages therefrom for communication to other computers via the Internet 14.

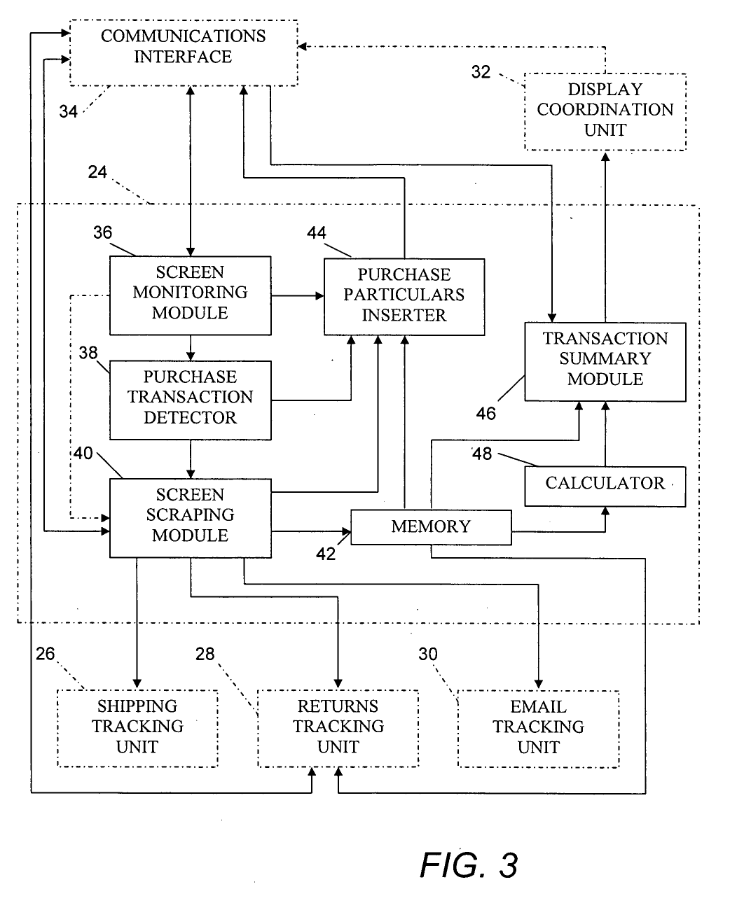

As illustrated in FIG. 3, shopping management unit 24 includes a software-implemented screen monitoring module 36 for automatically monitoring each screen displayed (for example, by Web browsers) on the monitors of consumer computers 16a, 16b, . . . 16n while the respective customer navigates the World Wide Web. Shopping management unit 24 further includes a software-implemented purchase transaction detector 38 operatively coupled to module 36 for automatically determining whether a customer is engaged in an online purchase transaction. Detector 38 determines from the format and the text of a World Wide Web page or other screen displayed on a consumer computer 16a, 16b, . . . 16n whether the customer is looking at a screen through which a purchase transaction can be made. Shopping management unit 24 also includes a screen-scraping module 40, of conventional programming for extracting information from HTML or XML display screens, operatively coupled to detector 38 and optionally directly to communication interface 34 for automatically collecting particulars of a purchase transaction upon the determination by detector 38 that the customer is engaged in a purchase transaction. Screen-scraping module 40 stores in a memory 42 the particulars of the particular transaction, as well the particulars of other online purchases made by the customer. To carry out their respective functions, screen-monitoring module 36, detector 38, and screen-scraping module 40 may cooperate with browser plug-in software and shopping management or desktop user interface software on the respective user computers 16a, 16b, . . . 16n.

Shopping management unit 24 additionally includes a software-implemented module 44 that is connected to purchase transaction detector 38 and screen-scraping module 40 for collecting shipping and payment particulars of the different customers. Module 40 communicates with memory 42 for storing therein customer names and one or more shipping addresses of each customer, for example, a home address and a business address, and for storing, for each customer, one or more credit or debit card numbers or electronic funds transfer accounts and passwords. Module 44 is connected directly or indirectly to communications interface 34 for inserting a customer's shipping and payment particulars into appropriate fields in an HTML or XML display screen, with the understanding and consent of the customer. Thus, the customer need not enter the shipping and payment particulars for each individual purchase made via the Internet 14.

Screen scraping module 40 of shopping management unit 24 may act in particular to detect and record a completed check-out screen after a purchase has been made and a confirmation is displayed. Module 40 works mainly on the confirmation screen to “screen-scrape” the desired information. In addition, module 40 may extract the specific forms and formats of each and every merchant from whom the consumer purchases goods and/or services. Module 40 stores the forms and formats in memory 42, for subsequent recognition, together with the personal information input by the user or consumer in the entry fields on the forms. This information is then accessible by purchase particulars inserter 44 upon a subsequent recognition by modules 40 and 44 of a previously stored form and format. Thus, subsequent shopping is facilitated since a customer will not have to input information on a variety of forms every time she goes to different merchants. The recordation of forms and formats by module 40 in memory substantially enhances accuracy and reliability in the insertion of purchase particulars including user IDs and passwords on check out screens.

Shopping management unit 24 additionally includes a software-implemented transaction summary module 46 for providing to consumer computers 16a, 16b, . . . 16n respective summary displays of collected and stored information pertaining to the online purchases made by the respective customers. Transaction summary module 46 may organize the purchase information according to different sorting schemes, at the option of the customer. For instance, purchases may be sorted chronologically or by merchant, type of item or service, cost, shipping method or shipper, etc. The type of item or service may be divided into broad categories such as food, clothing, transportation, telephone and communications, entertainment, business, etc. More specific categories may be included as well. Thus, the entertainment category may be subdivided into electronic goods, video rentals, theater tickets, sports tickets, etc. The individual customers may change from one sorting scheme to another, upon request.

Transaction summary module 46 may be coupled to a generic calculator 48 in server 12 for obtaining therefrom the total costs of various groupings of purchased goods and services. Thus, module 46 may request from calculator 48 the total amount spent on purchases made in a particular month, or the total amount spent on food during a specified period, or the total amount of shipping costs, etc. Transaction summary module 46 is coupled to display coordination unit 32 which organizes and formats the summary information from module 46 for display on the individual consumer computers 16a, 16b, . . . 16n.

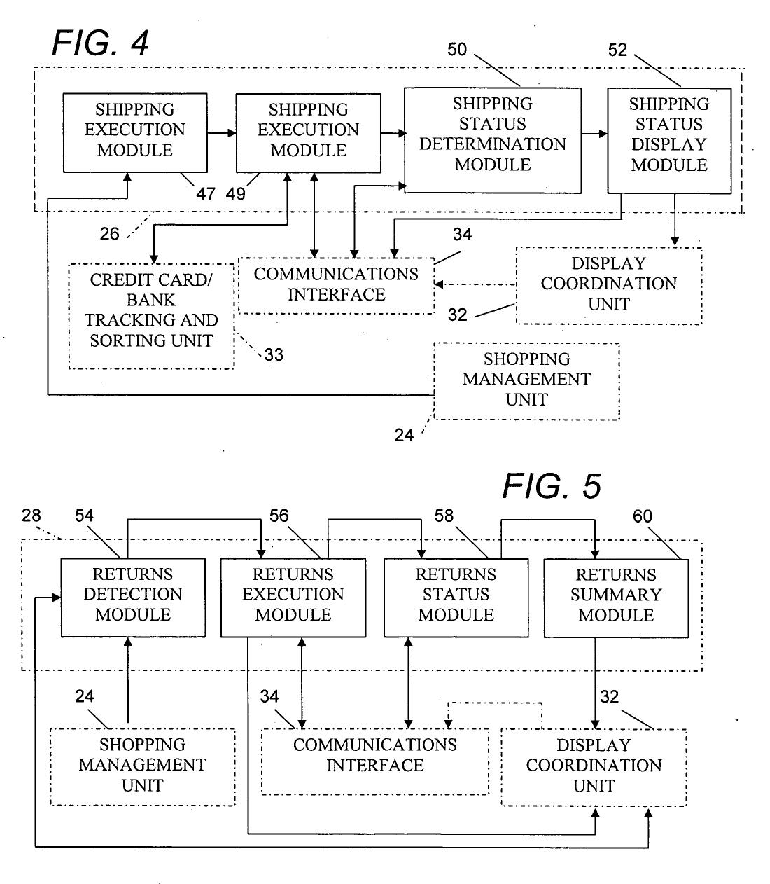

As depicted in FIG. 4, incoming shipment generation and tracking unit 26 includes a programming-implemented shipping detection module 47 linked to shopping management unit 24 and particularly to screen-scraping module 40 or memory 42 thereof for identifying purchases that have been made. A programming-implemented shipping execution module 49 is coupled to detection module 47 for consumer selection of which shippers are to be utilized to convey the purchased goods. Shipping execution module 49 is connected to the Internet 14 via communications interface 34 for communicating with shipper computers 20a, 20b, . . . 20p to arrange for shipments. Shipping execution module 49 may be operatively connected to credit-card/bank tracking and sorting unit 33 for facilitating payment of shipping charges. Shipping execution module 49 is tied to a programming-implemented shipping status determination module 50 in turn connected to the Internet 14 via communications interface 34 for contacting shipper computers 20a, 20b, . . . 20p to periodically monitor the status of incoming purchases. Module 50 is connected to a programming-implemented shipping status display module 52 included in incoming shipment generation and tracking unit 26 for collecting and collating shipment information pertinent to respective customers; purchase transaction. Module 52 cooperates with display coordination unit 32 to provide the customer or user with information pertaining to shipping status of purchased items.

As depicted in FIG. 5, returns shipment generation and tracking unit 28 incorporates a programming-implemented returns determination module 54 operatively linked to display coordination unit 32 and to communications interface 34 for monitoring consumer computers 16a, 16b, . . . 16n for requests made by customers to return purchased merchandise. Returns detection module 54 is operatively linked to shopping management unit and more particularly to memory 42 thereof for obtaining information about the purchased merchandise to be returned. Returns shipping generation and tracking unit 28 further incorporates a programming-implemented returns execution module 56 tied to shipping status determination module 54 and to communications interface 34 for contacting merchant computers 18a, 18b, . . . 18m and shipper computers 20a, 20b . . . . . . . 20p, as warranted, to carry out returns ordered via consumer computers 16a, 16b, . . . 16n. Returns execution module 56 may be operatively connected to credit-card/bank tracking and sorting unit 33 (see FIGS. 2 and 4) for facilitating the crediting of funds from merchants on returned goods and for facilitating the payment of shipping charges on returns. In addition, returns execution module 56 may be operatively linked to a printer (not shown) for printing out shipping labels including, for instance, bar-type identification codes. Module 56 may arrange for prepayment of the shipping costs via the Internet 14 and communications interface 34.

As further depicted in FIG. 5, returns shipment generation and tracking unit 28 also incorporates a programming-implemented returns status module 58 operatively linked directly or indirectly to communications module 34 for periodically monitoring the status of shipments of returned merchandise, to the extent that status information is available on shipper computers 20a, 20b, . . . 20p. A returns summary module 60 in unit 28 is operatively linked to display coordination unit 32 for providing updated shipping status information to consumer computers 16a, 16b, . . . 16q.

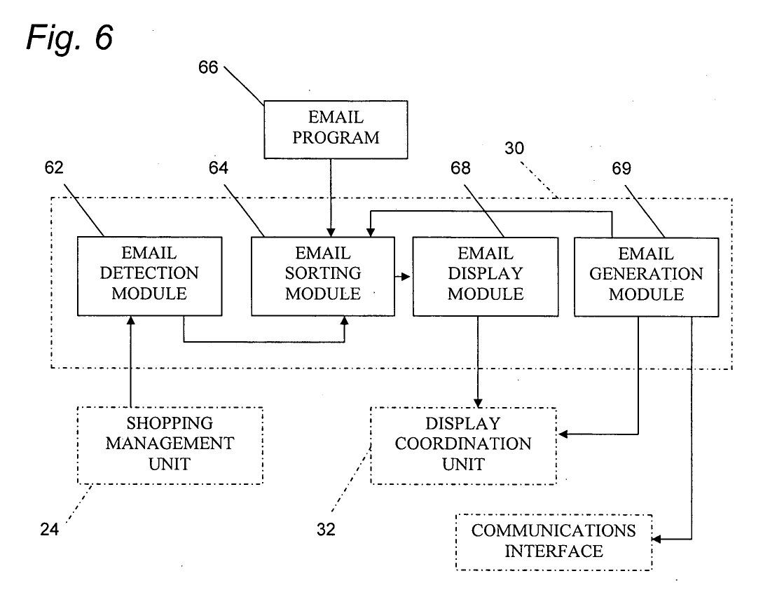

FIG. 6 shows details of email tracking and sorting unit 30 (FIG. 2). In particular unit 30 includes a programming-implemented email detection module 62 operatively coupled to shopping management unit 24 and particularly to screen-scraping module 40 or memory 42 thereof for detecting the names of merchants from whom purchases have been made. Unit 30 further comprises an email sorting module 64 operatively connected to detection module 62 and to an email program 66 on a respective consumer computer 16a, 16b, . . . 16n for detecting email messages to and from different merchant computers 18a, 18b, . . . 18m involved in the individual customer's purchase (and returns) transactions. Sorting module 64 extracts information from the email program pertaining to online purchases and sorts that information in accordance with one or more sorting schemes selectable by the individual user or customer. The information extracted by sorting module 64 may particularly include information pertaining to order confirmation, shipping status, and order cancellation status such as order confirmation numbers, shipper identities, shipping numbers, shipping dates, shipping costs, and order cancellation numbers and dates. The extracted information may be transmitted to display coordination unit 32 to update the transaction and purchase order information organized and communicated to the user. Additional sorting of email messages may be made according to merchant, product type, date, etc. Sorting module 64 is connected to an email display module 68 in turn cooperating with display coordination unit 32 for displaying the extracted and sorted email data on the individual consumer computers 16a, 16b, . . . 16n.

In the extraction and sorting of transaction and purchase order information, email tracking and sorting unit 30 must be compatible with in at least one email program, e.g., Microsoft Outlook, and have an ability to intercept and parse new incoming email in that email program. Email tracking and sorting unit 30 implements a classification algorithm that identifies whether an email is incoming from an online merchant/service provider where the customer engaged in a transaction. Email tracking and sorting unit 30 incorporates a data extraction and matching engine that can match customer orders/transaction activity to the email contents and update order statuses and other data accordingly.

If these functions of email tracking and sorting unit 30 are performed on a user computer 16a, 16b, . . . 16n, the user computer communicates with server 12 to obtain order information to be used by the classification and data extraction algorithms and push order/transaction updates. On a user computer 16a, 16b, . . . 16n, these functions may be performed by an email email plug-in. For instance, the plug-in identifies email originating from a merchant with whom the user placed a pending order (based on the state saved in server 12 and other heuristics). The plug-in may inform server 12 to change the state of an order from “placed” to “confirmed.” The plug-in picks up the relevant information and shipping tracking number from the email and associates it with the customer order.

Email tracking and sorting unit 30 may send email notifications to user computers 16a, 16b, . . . 16n informing the respective users of order status changes has changed from “confirmed” to “shipped.”

As a backup, email tracking and sorting unit 30 may check the user's email on a regular basis for order confirmation emails to capture new orders that were not captured using desktop capture. Such order may have been placed, for instance, by telephone or other route. If a new order is found, email tracking and sorting unit 30 extracts the same order information as the browser order capture. Checks by email tracking and sorting unit 30 supports all email checking protocols including POP, IMAP and HttpMail. The user has to provide the proper information such as email sign-on info as well as email server address.

A user preferably has the ability to control email plug-in settings. The user is promptly notified, using taskbar pop-ups, about actions the email plug-in is undertaking. The email intercept and data extraction features may be disabled at the user's option.

Email tracking and sorting unit 30 may additionally include email generation and transmission capabilities, carried out by a module 69. Module 69 is connected to the Internet 14 via communications interface 34 and, in response to user commands, sends emails to origination points. Unit 30 may store all received and sent emails for fast and easy communications. Consumers can choose to receive reminders and other information from merchants.

The online shopping management system described hereinabove implements an electronic shopping method wherein screen monitoring module 36 of shopping management unit 24 automatically monitors each screen displayed on a user's computer 16a, 16b, . . . 16n monitor while the user navigates the World Wide Web. Purchase transaction detection module 38 automatically determines whether the user is engaged in a purchase transaction during the monitoring of each screen. Screen-scraping module 40 automatically collects particulars of a purchase transaction upon detecting that the user is engaged in a purchase transaction and storing the particulars of the transaction in memory 42. For multiple purchases made by multiple users via respective consumer computers 16a, 16b, . . . 16n, screen-scraping module 38 stores particulars of the purchases in memory 42. The collected and stored particulars for each online purchase made via consumer computers 16a, 16b, . . . 16n may include an identification of a type of consumer or business item purchased, an identification of a seller or merchant of the consumer or business item purchased, and a purchase price. The purchase particulars stored by memory 42 may additionally include, for each online purchase made by the user, shipping fees and taxes paid.

Transaction summary module 46 provides to the user a summary display of collected and stored information pertaining to the online purchases made by the user. Module 46 organizes the displayed information according to any one of a plurality of different sorting schemes. The different sorting schemes may be by type of item purchased, by seller, and by price. The different sorting schemes may optionally include listing displayed information by shipping fees and taxes paid.

The purchase transaction summary displays on the monitors of consumer computers 16a, 16b, . . . 16n may include information pertaining to shipping status of purchased items. This information is collected, collated, and presented by shipping generation and tracking unit 26. The displayed shipping status may include shipment method and expected delivery date. The displayed status may further include information about delays and shipping problems. As indicated above, the shipping status information is typically obtained from the shipper computer 20a, 20b, . . . 20p via the Internet 14 and is sorted and organized by shipping status display module 52 for presentation to the respective users via computers 16a, 16b, . . . 16n.

The summary display provided by display coordination unit 32 may include interactive options for the user. For example, as discussed above, returns shipping generation and tracking unit 28 executes return options selectable by the user in response to the display of possible options by returns execution module 56 in cooperation with display coordination unit 32. Returns status module 58 displays to the user information tracking the status of the return shipments.

To reduce shipping costs for users of the COSMOS system, online buyers may be aggregated into a singular unit or “client” group. This aggregation may also facilitate the logistics of shipping, for example, by combining shipments to or from different users where the shipments are being sent to the same or proximate locations. Pursuant to this aggregation agenda, the “shipper” is not the merchant but is instead the customer. The customer essentially sends his or her shipper to pick the merchandise up and deliver it. So, for example, a user of the shipping management system may utilize it to electronically signal a designated shipping company to pick up a purchased item at the user's home address or at the address of the merchant, and deliver it to the user's address or the merchant's address, and the system will electronically submit to the shipping company a unique billing number assigned to the user so that the user becomes responsible for managing the shipment and return of his purchase and is responsible for paying the cost of such shipment which will be automatically billed by the system to his credit card.

The comprehensive online shopping management method performed by server computer 12 is performed while the user surfs the Web, making purchases at the Web sites of different merchants. Typically, at least some of the online purchases are made by the user after conducting a Web search using a search engine.

Server computer 12 may perform the additional service of providing credit card alerts to users. Alerts pertain to the charging or crediting of the users' credit or debit cards. Thus, where user returns a purchased item to a merchant, the system will track the return of such item and alert the user's credit card provider that a credit is due from the merchant. The system will then inform the user when such credit is received.

Credit card data is incorporated when charges are made, and when credits are received for returns. Normally, one does not know when he or she receives a credit for a return and has to wait and see the next month's credit card statement. The COSMOS system may alert users by retailer exactly when credit is received.

A shopping services provider, that is, a company carrying out the purchase tracking methodology described hereinabove, communicates with customers via the Internet 14 and assists customers in recording and organizing information pertaining to purchases made by the customers over the Internet from a plurality of different merchants via a plurality of different websites. In addition, that company may extend to the customers one or more and preferably three of more of the following: (i) providing credit card alerts to the customers via Internet 14, (ii) tracking merchandise shipments, (iii) providing insurance against incomplete merchandise receipt, (iv) providing an extended return period, providing a guaranteed return period, (v) providing an extended warranty period, (vi) providing a guaranteed warranty period, (vii) providing insurance on returned merchandise, (viii) providing frequent buyer points, (ix) providing gift cards, and (x) providing an alternative dispute resolution procedure. Users are aggregated into a single cohesive “client” or “group” so that the users become an entity whereby each user can organize, control, manage, and pay for, his own individual shipping and return functions as they relate to items purchased and recorded on the system.

Additional services extended to customers in an on-line shopping management system pursuant to the present invention may include shipment holding features, for example, holding users' purchases while the users are on vacation. Another service is to provide, to selected merchants, additional shipping methods such as local store pick-ups. A selectable setting may enable or require shopping management unit 24 of server computer 12 to automatically email user computers 16a, 16b, . . . 16n when there is a change of a previously identified nature detected in the status of the respective user's purchases. For example, a shipping status message may be automatically dispatched when an order previously placed by a user arrives at a pick-up location.

It is to be noted that the system and methodology described hereinabove may be carried out in different ways. Pursuant to one scenario, consumer computers 16a, 16b, . . . 16n download software which tracks the respective users' online purchasing behavior and then sends data back to COSMOS server 12 for translation onto the consumers' Web pages on the COSMOS system. Alternatively, consumers essentially go shopping “through” the COSMOS system when they hit the shopping buttons on their ISP providers such as Yahoo! and aol. In that case, there is an imbedded link to COSMOS system at that level. The system becomes activated when the user is directed to “shop” through the system's computers 12, so that whenever the user goes on the World Wide Web he invisibly takes along with him the system's tracking and recording devices.

Accordingly, one of ordinary skill in the art will recognize that various functions of the COSMOS system may be performed on consumer computers 16a, 16b, . . . 16n and other functions performed on serer computer 12. Thus, various components of server computer 12 illustrated in FIGS. 2-6 may be implemented in whole or in part in software loaded onto consumer computers 16a, 16b, . . . 16n. Alternatively or additionally, various components of server computer 12 may be distributed throughout one or more server computers that cooperate via the Internet or a private hardwired network.

Where users' personal information (names, addresses, credit or debit card numbers, purchases, email, etc.) are stored in some form in memory 42 of a server computer 14, access to the consumers' COSMOS pages, sorted by retailer, is obtained only after entry of a PIN or other code, and a password. Thus, the user is assisted in enjoying the shopping experience without annoying intrusions.

The online shopping management system can be used to track requests for catalogs, samples, swatches, and other product information by vendor. Thus, any transactions made over the Web may be tracked and summarized for display. As indicated elsewhere herein, the COSMOS system can equally apply to services purchased online.

The online shopping management system described hereinabove is equally applicable to businesses as well as individuals. Any “person” who orders items or services over the internet for free or for payment can use the system and manage their activity through the system. Thus, the word “user” is used herein to designate artificial or legal entities, as well as natural persons.

Many of COSMOS functions operate independently of the seller or provider of the items or services. In most cases the data is collected with the consent of the shopper, not the shipper or provider.

With respect to the shipping and return functions performed by the computer modules shown in FIGS. 4 and 5, the COSMOS system allows the consumer (individual or business) to become the shipper of her own items as opposed to the conventional process where the shipper is the merchant or seller. The COSMOS company may provide its users or customers with pre-negotiated shipping rates by accumulating all COSMOS shoppers into a group for bargaining purposes. Then when a user or customer buys something over the Internet 14, server computer 12 sends an electronic signal to a shipping computer 20a, 20b, . . . 20p on the user's behalf and with the user's shipping account number for billing purposes, asking the shipping company to go pick up the merchandise from the respective merchant's address and send it to the user's home or business. Similarly, the returns process works the same way—the user can send the return back by bringing the shipping company to her house to collect it at rates negotiated for her by the COSMOS company.

The shopping management or desktop user software on user computers 16a, 16b, . . . 16n may run in an offline mode and synchronize data and request order changes on connection (in the way the Outlook mail program works in an offline mode).

In order to implement protection against credit card fraud, the shopping management or desktop user interface software on user computers 16a, 16b, . . . 16n is configured to cooperate with shopping management unit 24 and credit card/bank tracking and sorting unit 33 to utilize one time credit card numbers for discrete purchases over limited periods of time and/or with limited numbers or merchants. The COSMOS server 12 can interface to any search engine and help, complete, perfect, control, and manage the output of the search which leads to an online transaction. The COSMOS server 12 may enable a user to access and manage their on-line shopping not only from home computers but from any computer 16a, 16b . . . 16n connected to the Internet 14. Users are thus able to see orders captured by COSMOS, view the status of the orders, change settings and request changes and services the same way the users can do that from their COSMOS desktop control panels.

It is to be noted that the COSMOS system described herein may also track other kinds of financial transactions other than purchases of goods and services. For instance, where an individual user engages in charitable contributions, the COSMOS system may track the amounts and dates of the donations, as well the charities and other not-for-profit organizations that receive the funds. The charities may be organization by kind and amount donated, etc.

Even if no money exchanges hands, the COSMOS system may be used to track amounts or numbers and kinds of goods and services which are being transferred. This functionality can be useful in consignment arrangements as well as in the provision of sample goods and services.

The COSMOS on-line shopping management system may additionally include ancillary on-line services such as instant messaging, whereby users can share their positive and negative shopping experiences with friends and family.

Although the invention has been described in terms of particular embodiments and applications, one of ordinary skill in the art, in light of this teaching, can generate additional embodiments and modifications without departing from the spirit of or exceeding the scope of the claimed invention. For example, many of the functions performed by server computer 12 may be performed in whole or in part by browser and email plug-ins and/or by shopping management or desktop user interface software on user computers 16a, 16b, . . . 16n. Thus, the various data collection and sorting functions may be performed centrally or locally or in a portioned load distributed among one or more server computers 12 and user computers 16a, 16b, . . . 16n. Where shopping management operations are carried at least in part by user computers 16a, 16b, . . . 16n, the functional blocks depicted in FIGS. 2-6 are located in whole or in part on the user computers, with communications functionality as warranted for cooperating with one or more server computers 12. In a distributed processing system, the proportion of operations carried out by various components of the system of FIG. 1 may vary from moment to moment in accordance with instantaneous load requirements and processor availabilities.

Accordingly, it is to be understood that the drawings and descriptions herein are proffered by way of example to facilitate comprehension of the invention and should not be construed to limit the scope thereof.

1. An online shopping management method comprising:
while a user operates computer apparatus to navigate the World Wide Web, automatically accessing the user's computer apparatus to monitor information on each screen displayed on a monitor of the computer apparatus;
during the accessing of the computer apparatus, automatically determining whether the user is engaged in a transaction;
upon detecting that the user is engaged in a transaction, automatically collecting particulars of said transaction;
storing in a memory the particulars of said transaction and the particulars of multiple-online transactions made by the user; and
providing to the user a summary display of collected and stored information pertaining to the online transactions made by the user.

2. The method defined in claim 1 wherein the providing of said summary display includes organizing the displayed information according to any one of a plurality of different sorting schemes.

3. The method defined in claim 2 wherein the collected and stored particulars for each online transaction made by the user include an identification of a type of item purchased, an identification of a seller of the item purchased, and a purchase price, the different sorting schemes including listing displayed information by type of item purchased, by seller, and by price.

4. The method defined in claim 3 wherein the collected and stored particulars for each online transaction made by the user further include shipping fees and taxes paid, the different sorting schemes including listing displayed information by shipping fees and taxes paid.

5. The method defined in claim 1 wherein the providing of said summary display includes displaying information pertaining to shipping status of purchased items.

6. The method defined in claim 5 wherein the displayed shipping status includes shipment method and expected delivery date.

7. The method defined in claim 6 wherein the displayed status further includes information about delays and shipping problems.

8. The method defined in claim 1 wherein the providing of said summary display includes interactive options for the user.

9. The method defined in claim 8 wherein said interactive options include return options selectable by the user to return purchased items.

10. The method defined in claim 9, further comprising displaying returns shipping tracking information to the user.

11. The method defined in claim 1, further comprising monitoring email of said user to and from different merchants, the providing of said summary display including displaying information pertaining to transaction status.

12. The method defined in claim 11, further comprising sorting the email to and from the different merchants, the displaying of the information pertaining to email including displaying email in sorted groups.

13. The method defined in claim 12 wherein the sorted groups include by product type and by merchant, alternatively.

14. The method defined in claim 1 wherein the collected and stored particulars for each online transaction made by the user include an identification of a type of item purchased, an identification of a seller of the item purchased, and a purchase price.

15. The method defined in claim 14 wherein the collected and stored particulars for each online transaction made by the user further include shipping fees and taxes paid.

16. The method defined in claim 1 wherein the providing of said summary display includes calculating sums of amounts spent on types of purchases in different categories.

17. The method defined in claim 16 wherein the different categories include a food category, a transportation category, a clothing category, and an entertainment category.

18. The method defined in claim 1 wherein at least some of the online transactions made by the user are effectuated via different Web sites.

19. The method defined in claim 1 wherein at least some of the online transactions are made by the user after conducting a Web search using a search engine.

20. The method defined in claim 1 wherein the collecting of particulars as to a transaction includes using screen scraper software.

21. The method defined in claim 1, further comprising storing consumer identification information pertaining to the user and automatically inserting individual pieces of the stored consumer identification information in respective data entry fields of a purchase screen on the user display.

22. The method defined in claim 1, further comprising displaying inbound shipping tracking information to the user.

23. The method defined in claim 1, further comprising displaying credit card alerts to the user.

24. An online shopping management system comprising a computer system including at least one server computer, said computer system being provided with software for assisting users in recording and organizing information pertaining to transactions executed by the users over a global computer network, said transactions involving communicating with a plurality of different providers via a plurality of different websites.

25. The shopping management system defined in claim 24 wherein said software is first software and wherein said computer system is further provided with second software taken from the group consisting of software for tracking status of merchandise shipping from different merchants, software for tracking status of return merchandise shipments to the different merchants and by individual purchases, and software for tracking email to and email from any given user pertaining to purchases made by said given user.

26. The shopping management system defined in claim 25 wherein said first software includes software for automatically accessing a user's computer apparatus to monitor information on each screen displayed on a monitor of the user's computer apparatus while the user navigates the World Wide Web, automatically determining whether the user is engaged in a purchase transaction, automatically collecting particulars of said transaction upon detecting that the user is engaged in a purchase transaction, storing in a memory the particulars of said transaction and the particulars of multiple-online purchases made by the customer, and providing to the user a summary display of collected and stored information pertaining to the online purchases made by the user.

27. The shopping management system defined in claim 25 wherein said second software includes programming for displaying information pertaining to shipping status of purchased items.

28. The shopping management system defined in claim 25 wherein said second software includes programming for displaying and acting on options selectable by the user to return purchased items.

29. The shopping management system defined in claim 25 wherein said second software includes programming for displaying information pertaining to email to and from the different merchants.

30. The shopping management system defined in claim 25, further comprising additional software for calculating sums of amounts spent by individual customers on types of purchases in different categories.

31. The shopping management system defined in claim 24 wherein said software includes software for automatically accessing a user's computer apparatus to monitor information on each screen displayed on a monitor of the computer apparatus while the user navigates the World Wide Web, automatically determining whether the user is engaged in a transaction, automatically collecting particulars of said transaction upon detecting that the user is engaged in a transaction, storing in a memory the particulars of said transaction and the particulars of multiple-online transactions engaged in by the user, and providing to the user a summary display of collected and stored information pertaining to the online transactions carried out by the user.

32. A business method comprising:
communicating with customers via a global computer network;
assisting the customers via the global computer network in recording and organizing information pertaining to purchases made by the customers over the global computer network from a plurality of different merchants via a plurality of different websites;
extending to the customers at least three services taken from the group consisting of:
providing credit card alerts to the customers via the computer network,
tracking merchandise shipments,
providing insurance against incomplete merchandise receipt,
providing an extended return period,
providing a guaranteed return period,
providing an extended warranty period,
providing a guaranteed warranty period,
providing insurance on returned merchandise,
providing frequent buyer points,
providing gift cards, and
providing an alternative dispute resolution procedure; and
aggregating users into a single cohesive “client” or “group” so that the users become an entity whereby each user can organize, control, manage, and pay for, his own individual shipping and return functions as they relate to items purchased and recorded on the system.

33. The method defined in claim 32, further comprising providing second software taken from the group consisting of software for tracking status of merchandise shipping from the different merchants, software for tracking status of return merchandise shipments to the different merchants and by individual purchases, and software for tracking email to and email from any given customer pertaining to purchases made by said given customer.
